(19) United States
(12) Patent Application Publication
(10) Pub. No.: US 2002/0011079 A1
(43) Pub. Date: Jan. 31, 2002

(54) Process for producing glass substrate for information recording media, the glass substrate, and information recording device

(75) Inventor: Norihiro Fujioka, Osaka (JP)

Correspondence Address: SUGHRUE, MION, ZINN, MACPEAK & SEAS, PLLC, 2100 Pennsylvania Avenue, N.W., Washington, DC, 20037, US

(73) Assignee: NIPPON SHEET GLASS CO., LTD.

(21) Appl. No.: 09/880,751

(22) Filed: Jun. 15, 2001

(30) Foreign Application Priority Data
Jun. 16, 2000 (JP) P.2000-180820

(51) Int. Cl. C03C 19/00; C03B 18/02; C03B 18/14

(52) U.S. Cl. 65/61; 65/99.2

(57) ABSTRACT

A process for producing a glass substrate for information recording media which comprises polishing one side of a float glass in a finish polishing step to remove a surface layer therefrom in a thickness of 5 μm or larger and keeping the one side of the float glass not substantially in contact with any jig in each of the processing steps other than the finish polishing step. The number of processing steps in glass substrate production is reduced by utilizing only one side of a float glass as a data recording side to thereby attain a reduced production cost and stable supply of glass substrates and thus contribute to the progress of an information-oriented society.

### FIELD OF THE INVENTION

The present invention relates to a process for producing a glass substrate for information recording media by processing a float glass. The invention further relates to an information recording medium glass substrate obtained by polishing a float glass to remove a thin surface layer therefrom, and to an information recording device having the glass substrate integrated thereinto.

### BACKGROUND OF THE INVENTION

With progress in the handling of digital information, information recording devices represented by hard disks are always required to have a larger recording capacity. In order for an information recording device to have an increased recording capacity, it should employ an information recording medium having a higher recording density and a larger recording area. From this standpoint, glass substrates having high surface smoothness have conventionally been preferred for use in information recording media, and both sides of such a glass substrate have been utilized as data recording sides. Processes for producing a glass substrate include a method in which a flat glass produced by the float process (float glass) is cut into a disk shape and a method in which a molten glass is poured into a mold to form a disk-shaped glass. At present, float glasses are mainly used as glass substrates because the float process can produce a large amount of a homogeneous glass at one time.

A process for producing a float glass is briefly explained below. First, raw glass materials including silica sand are melted in a melting furnace. The resulting molten glass is continuously discharged onto a bath of molten tin (Sn). Since the molten glass has a smaller specific gravity than tin, it floats on the molten tin. This molten glass floating on the molten tin is pulled at a constant rate from the cooling-line side, whereby the molten glass is formed into a flat shape. In this process, the molten tin is in contact with the lower side (bottom side) of the floating glass and penetrates into a surface layer thereof up to a depth of about 40 μm. On the other hand, the upper side (top side) of the floating glass does not come into direct contact with the molten tin. However, vaporized tin present in the atmosphere penetrates into the top side. As a result, a tin-penetrated layer is formed also on the top side in a thickness of about several micrometers. The flat glass pulled out from the bath of molten tin is sent to the cooling line, where the bottom side comes into contact with conveying rollers. After the flat glass is sufficiently cooled, it is cut into an appropriate size and piled up on a pallet.

A float glass is processed into a glass substrate for information recording media (hereinafter referred to simply as a “glass substrate”) through the following processing steps.

1. Raw-Plate Cutting Step

The float glass is cut into a desired size of which a disk can be cut out.

2. Disk Cutout Step

Each cut glass piece is incised with a glass cutter to form circular lines (cracks) thereon, and the cracks are propagated to thereby cut out a glass disk.

3. Beveling Step

The outer and inner edges of the glass disk are beveled.

4. Edge Polishing Step

The outer and inner edges of the glass disk are polished to impart a desired shape thereto.

5. Rough Polishing Step

The data recording side is polished with an abrasive material having a large particle diameter so as to remove a surface layer having a desired thickness.

6. Finish Polishing Step

The polishing mars and foreign substances remaining on the data recording side are eliminated and the surface is mirror-finished.

7. Cleaning Step

Foreign substances and other substances adherent to the glass disk are removed.

The glass substrate thus produced is inspected as to whether its thickness is within the on-specification range and whether the substrate is free from mars or adherent foreign substances. The thickness tolerance is exceedingly small and is about ±8 μm, although it slightly varies depending on substrate kind. Float glasses have large thickness fluctuations on the order of micrometer although they have extremely high surface smoothness. Consequently, the float glasses can be utilized as glass substrates only when they are processed by the rough polishing step (step 5) described above.

On the other hand, information recording devices have diversified with respect to uses and quality requirements, and there are cases where cost is regarded as more important than information recording capacity. For satisfying such demand, it is necessary to make investigations not only on techniques for increasing recording capacity as in conventional investigations, but also as to how the production cost is reduced.

As described above, the rough polishing step (step 5) is conducted in order to regulate the thickness of glass substrates. In this rough polishing step, a polishing pad is rotated while being pressed against the glass disk, and an abrasive material is supplied thereto to gradually grind the surface of the glass disk. This step hence results in polishing mars (microcracks) on the polished surface. Since the size of these polishing mars is on the order of micrometer, the polishing mars present on the data recording side can be a factor contributing to a decrease in information recording density. The surface smoothness required of the data recording side is on the order of nanometer and this necessitates the finish polishing step (step 6).

Float glasses intrinsically have exceedingly high surface smoothness and can hence be utilized as glass substrates without any processing as long as no mars are formed on the surface thereof after glass forming, on the assumption that there is no problem concerning the thickness thereof. Virtually, however, the thickness of the float glasses for use as substrates poses a problem. This is because these glass substrates for information recording media have been designed so that each side thereof is utilized as a data recording side. For example, if glass substrates in which one side only is utilized as a data recording side are to be produced, they have a larger thickness tolerance and this leads to diminished occurrence of thickness failures. As a result, the cost of the production of glass substrates is reduced.

### SUMMARY OF THE INVENTION

The invention has been achieved in view of the above-described problem of conventional techniques.

Accordingly, an object of the invention is to reduce the number of processing steps in glass substrate production by utilizing one side only of a float glass as a data recording side to thereby attain a reduced production cost and stable supply of glass substrates and thus contribute to the progress of an information-oriented society.

In order to accomplish the object described above, the invention provides a process for producing a glass substrate for information recording media which comprises polishing one side of a float glass in a finish polishing step to remove a surface layer therefrom in a thickness of 5 μm or larger and keeping the one side of the float glass not substantially in contact with any jig in each of the processing steps other than the finish polishing step.

In a preferred embodiment of the process for glass substrate production of the invention, the one side of the float glass is polished in the finish polishing step to remove a surface layer therefrom in a thickness of from 5 to 40 μm.

In another preferred embodiment of the process for glass substrate production of the invention, the one side of the float glass which is kept not substantially in contact with any jig in each of the processing steps other than the finish polishing step is the top side.

The invention further provides a glass substrate for information recording media produced by the process of the invention, wherein the one side of the float glass which was kept not substantially in contact with any jig in each of the processing steps other than the finish polishing step is utilized as a data recording side.

The invention furthermore provides an information recording device having the glass substrate of the invention integrated thereinto.

### BRIEF DESCRIPTION OF THE DRAWING

The Figure is a diagrammatic view showing the important part of the apparatus used in a finish polishing step.

In the drawing, the Reference Numerals are:

1

Glass disk

21

Inner jig

22

Outer jig

23

Carrier

25

Abrasive slurry containing cerium oxide

26

Rotating shaft

31

Polishing pad

32

Platen having polishing pad bonded thereto

### DETAILED DESCRIPTION OF THE INVENTION

The present invention is explained in detail below.

In a float glass production line, the bottom side of the float glass comes into contact with conveying rollers and, as a result, mars of a size on the order of micrometer are apt to be formed in the contact areas. On the other hand, the top side of the float glass comes into contact with suction pads upon transportation and is in contact with an interleaving paper on a pallet. Because of this, the top side also suffers mars although this marring is slight as compared with that on the bottom side. It is therefore necessary to conduct polishing for removing mars no matter which of the bottom side and top side may be used as a data recording side. Since the top side has shallower mars than the bottom side, it is preferred to use the top side as a data recording side. Many experiments made by the present inventors revealed that the mars formed on the top side of a glass disk are almost completely eliminated by polishing the side to remove a surface layer in a thickness of 5 μm or larger therefrom.

On the other hand, a tin-penetrated layer having a thickness of about 40 μm has been formed on the bottom side of the float glass. Although removal of a 5-μm surface layer from each side by polishing is effective in removing the tin-penetrated layer from the top side, it leaves most of the tin-penetrated layer on the bottom side. The residual tin-penetrated layer may cause warpage when the glass substrate is thin and has low rigidity. It is therefore preferred to polish one side of the glass disk to remove a surface layer therefrom in a thickness of from 35 to 40 μm in order to remove the tin-penetrated layer also from the bottom side. The rough polishing step (step 5) leaves polishing mars having a depth of about 10 μm, and it is said that for eliminating these mars, the finish polishing step (step 6) should be conducted so as to remove a surface layer in a thickness of from 2 to 3 times. From this standpoint, an effect characteristic of the invention is that even a glass disk in which one side has undergone polishing for removing a surface layer in a thickness of 40 μm or smaller can be utilized as a glass substrate. Consequently, the thickness of the surface layer to be removed from one side by polishing should be 5 μm or larger and is preferably not larger than 40 μm, more preferably not larger than 35 μm.

In order to process a float glass into a glass substrate, the glass should be subjected to the processing steps described above, beginning with the raw-plate cutting step (step 1) and ending with the cleaning step (step 7), provided that the rough polishing step (step 5) is unnecessary. The unnecessariness of the rough polishing step is due to the high homogeneity and high surface smoothness of float glasses. Glasses other than float glasses have poor homogeneity, e.g., differences in composition or density between a surface layer and an inner layer. This is because in producing these glasses other than float glasses, the molten glass is rapidly cooled and hence comes to have large fluctuations in temperature. In particular, surface layers thereof have poor homogeneity, e.g., fluctuations in composition. Because of this, even when a glass other than float glasses is polished to remove a surface layer, there are cases where this polishing results in warpage rather than heightens the surface smoothness of the glass disk. It has therefore been necessary to polish the surface of the glass disk to remove a surface layer in a thickness of 100 μm or larger in order to expose a homogeneous inner layer. In this invention, the use of a float glass eliminates the necessity of the rough polishing step (step 5), whereby processing steps for glass substrate production can be shortened. Furthermore, since no polishing mars are formed, the thickness of the surface layer to be removed by the finish polishing step (step 6) can be reduced to 40 μm or smaller. In addition, since one side only of the glass substrate is used as a data recording side, the omission of the rough polishing step (step 5) does not pose any problem attributable to thickness fluctuations of the float glass.

As described above, since the processing steps for glass substrate production according to the invention are substantially the same as conventional ones except that part of these is omitted, conventional processing apparatus can be utilized in the invention without any modification.

Before a float glass is subjected to the processing steps for glass substrate production, which side of the float glass is to be used as a data recording side is decided. This side of the float glass is kept not substantially in contact with any jig in each of the processing steps other than the finish polishing step (step 6). The term “kept not substantially in contact with any jig” as used herein means that the main part of the data recording side is prevented from being marred. Examples of means for attaining this include a technique in which the glass disk is fixed by using a chuck to hold it by an inner peripheral part thereof ranging from the inner edge and having a width of from 2 to 2.5 mm in the beveling step (step 3) and the edge polishing step (step 4). This part held with a chuck (hereinafter referred to as “chuck part”) is the area to be covered with a spacer when the glass substrate is integrated into an information recording device. Namely, the chuck part is a part which cannot serve as a data recording part, i.e., as the main part of the data recording side, and in which the presence of mars does not pose a problem.

For keeping one side of the float glass not substantially in contact with any jig in each of the processing steps other than the finish polishing step (step 6), the following methods can be used. In the raw-plate cutting step (step 1), the float glass is placed on a cutting table and incised with a glass cutter to form lines (cracks). These cracks are propagated to thereby cut the glass into a given size. The side which is not in contact with the cutting table in this processing (hereinafter referred to as “non-contact side”) is the side to be used as a data recording side. Because of this, it is preferred to ascertain the top side before the float glass is placed on the cutting table. After the cutting, the resultant float glass pieces are placed in a case in which the glass comes into contact with the case only at edges thereof and/or on the side thereof which was in contact with the cutting table (hereinafter referred to as “contact side”). Alternatively, the float glass pieces are separately sent to the subsequent processing step. After the cutting, the float glass may be marked in order to distinguish the non-contact side from the contact side. In the case of marking the non-contact side, it is preferred to use a marking pen for glasses.

In the disk cutout step (step 2), the contact side of each float glass piece is wholly fixed with a chuck, and circular cracks are formed with a glass cutter. Subsequently, the outer and inner peripheral parts are heated with a burner to propagate the cracks by means of thermal expansion and thereby cut out a glass disk. The glass disk thus cut out is conveyed to the subsequent processing step while preventing the non-contact side thereof from being marred.

In the beveling step (step 3), the glass disk is fixed to a beveling apparatus by holding the whole contact side with a chuck and pressing a driving plate against the chuck part on the non-contact side. While the glass disk is kept in the fixed state, a grinding wheel is brought into contact with the outer and inner edges to bevel them. After this processing, each glass disk is conveyed to the subsequent processing step in the same manner as that described above.

In the edge polishing step (step 4), the glass disks can be treated either by a sheet-by-sheet method in which glass disks are separately processed one by one or a batch method in which glass disks are processed at a time. In the case of the sheet-by-sheet method, each glass disk is fixed in the same manner as in the beveling step (step 3). On the other hand, in the case of the batch method, two or more glass disks can be fixed to one rotating shaft by interposing driving plates coming into contact with the glass disks at the chuck parts only. After this processing, each glass disk is conveyed to the subsequent processing step in the same manner as that described above.

The rough polishing step (step 5) is omitted.

In the finish polishing step (step 6), an apparatus for sheet-by-sheet or batch polishing, e.g., that described in JP-A-2000-105922 (the term “JP-A” as used herein means an “unexamined published Japanese patent application”), is used to polish the non-contact side of each glass disk to remove a surface layer therefrom in a thickness of 5 μm or larger. In this polishing, the surface layer removed from the contact side and that removed from the non-contact side basically have the same thickness. However, by employing polishing pads differing in hardness or shape, the thicknesses of the surface layers removed by polishing from the respective sides can be separately regulated so as to differ from each other. After this processing, each glass disk is conveyed to the subsequent processing step in the same manner as that described above.

In the cleaning step (step 7), the glass disks were separately hung on claws at the inner edges thereof. These glass disks are immersed in a bath of an aqueous hydrofluoric acid solution, a bath of an aqueous alkali solution, a bath of pure water, and an isopropyl alcohol (IPA) bath successively and then introduced into an IPA vapor drying chamber.

The method described above is a mere example usable for carrying out the invention, and the process of the invention should not be construed as being limited thereto. For example, in the raw-plate cutting step (step 1), the non-contact side may be coated with a surface coating film before the float glass is incised with a cutter to form lines. This coating enables the non-contact side to be even less apt to be marred.

Furthermore, in the disk cutout step (step 2), a laser may be used in place of the glass cutter. In this case, the float glass pieces are irradiated with a laser beam to thereby form thermally expanded parts on the surface thereof and then immersed in a highly corrosive solution such as a hydrofluoric acid solution. In the acid solution, selective dissolution occurs due to corrosion by the acid in the parts having a reduced density as a result of the thermal expansion. Thus, glass disks are cut out. This processing has an advantage that the edges of each resultant glass disk are smooth due to corrosion by the acid and, hence, the beveling (step 3) is unnecessary.

In the finish polishing step (step 6), each glass disk may be immersed alternately in an acid solution and an alkali solution to thereby remove a surface layer in a thickness of 5 μm or larger from one side thereof without using a polishing pad and an abrasive material. In this case, since a surface layer is removed by etching, no polishing mars are formed and the possibility that the data recording side might have residual mars is extremely low as long as the non-contact side is the top side.

The glass substrate thus produced is coated successively with an undercoat film made of aluminum, chromium, or a chromium-molybdenum alloy, a magnetic film made of a cobalt-platinum-chromium alloy, chromium-molybdenum alloy, or cobalt-platinum-chromium alloy, a protective film made of hydrogenated carbon, etc. with sputtering apparatus in an ordinary way to constitute an information recording medium. This information recording medium is integrated into an information recording device in an ordinary way.

The invention will be explained in more detail below by reference to Examples and Comparative Examples.

### Production of Glass Substrates

As a raw glass plate was used a 1.15 mm-thick float glass having an aluminosilicate composition. It was ascertained that the top side of this raw glass plate had contacted only with suction pads during piling on a pallet and with an interleaving paper on the pallet. This float glass was subjected to the following processings to produce glass substrates.

1. Raw-Plate Cutting Step

The float glass was placed on a cutting table so that the top side faced upward so as to be a non-contact side. This non-contact side was incised with a cutter to form cracks thereon to thereby cut the glass into a size of 80×80 mm. The resulting glass pieces were marked on the non-contact side with a marking pen. Thereafter, the glass pieces were put in a resin case having slits into which the corners of the glass were to be inserted. The glass pieces thus cased were conveyed to the subsequent processing step.

2. Disk Cutout Step

The side having no marking was wholly contacted with a chuck to fix each glass piece to a cutter. The non-contact side was incised with the cutter to form lines. Subsequently, a burner flame was applied to the outer circular line to propagate the outer crack by means of thermal expansion. The inner crack also was propagated in the same manner to cut out a glass disk having an outer diameter of 65.0 mm and an inner diameter of 20.0 mm. The resulting glass disks were put in a resin case in which the disks were held by the edge. The glass disks thus cased were conveyed to the subsequent processing step.

3. Beveling Step

Each glass disk was fixed to a beveling apparatus by contacting the whole contact side of the glass disk with a chuck and pressing a clamping plate against the chuck part on the non-contact side. A grinding wheel was brought into contact with the edges of this glass disk to bevel them. After the beveling, the glass disks were put in a resin case in which the glass disks came into contact with the case only on the contact side thereof. The glass disks thus cased were conveyed to the subsequent processing step.

4. Edge Polishing Step

Several tens of glass disks were fixed to one rotating shaft by interposing driving plates therebetween which came into contact with the glass disks at the chuck parts only. While this rotating shaft was kept rotating, a roll brush rotating in the opposite direction was brought near to the rotating shaft so that the roll brush came into contact with the edges of the glass disks. While the rotating shaft and the roll brush were kept in this state, a suspension of cerium oxide was applied to this roll brush to conduct edge polishing. After the edge polishing, the glass disks were put in a resin case in which the glass disks came into contact with the case only on the contact side thereof. The glass disks thus cased were conveyed to the subsequent processing step.

5. Rough Polishing Step

The rough polishing step was omitted.

6. Finish Polishing Step

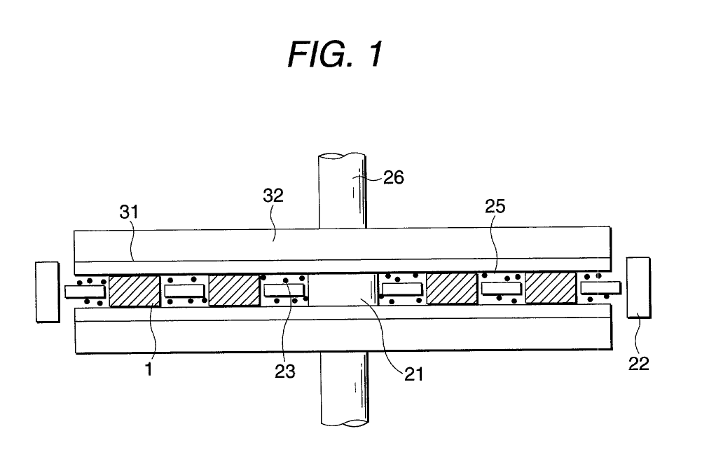

Finish polishing was conducted with the apparatus shown in FIG. 1, in which nine glass disks were polished in each polishing operation. Cerium oxide (average particle diameter, about 1.0 μm) was used as abrasive grains to polish each side of glass disks 1 disposed in an FRP carrier 23. A suede pad (trade name, Ciegal 1900; manufactured by Daiichi Lace) was used as polishing pads 31. After the finish polishing, the glass disks were put in a resin case in which the glass disks came into contact with the case only on the contact side thereof. The glass disks thus cased were conveyed to the subsequent processing step.

7. Cleaning Step

The glass disks were separately hung on stainless-steel claws so that each glass disk came into contact with the claw only at the inner edge thereof. These glass disks were immersed in a bath of an aqueous hydrofluoric acid solution (0.1% by weight), a bath of an aqueous alkali solution (0.1% by weight), a pure water bath, and an isopropyl alcohol (IPA) bath successively for 2 minutes each and then placed in an IPA vapor drying chamber for 2 minutes. Thus, glass substrates were obtained.

The glass substrates thus obtained were visually examined for mars or adherent foreign substances on the non-contact side, i.e., data recording side. In this visual examination, the non-contact side was illuminated with an inspection light (slide projector manufactured by Cabin) as a light source, and the presence of mars or foreign substances was judged based on the scattering of reflected light.

### EXAMPLE 1

In the finish polishing step (step 6), glass disks were polished so as to remove surface layers in thicknesses of 20/10 μm (both sides/non-contact side). The polishing time was 10 minutes. Of the nine glass substrates thus obtained, eight were judged non-defective in the visual examination.

### EXAMPLE 2

In the finish polishing step (step 6), glass disks were polished so as to remove surface layers in thicknesses of 40/20 μm (both sides/non-contact side). The polishing time was 20 minutes. Of the nine glass substrates thus obtained, eight were judged non-defective in the visual examination.

### EXAMPLE 3

In the finish polishing step (step 6), glass disks were polished so as to remove surface layers in thicknesses of 60/30 μm (both sides/non-contact side). The polishing time was 30 minutes. Of the nine glass substrates thus obtained, all were judged non-defective in the visual examination.

### EXAMPLE 4

In the finish polishing step (step 6), glass disks were polished so as to remove surface layers in thicknesses of 80/40 μm (both sides/non-contact side). The polishing time was 40 minutes. Of the nine glass substrates thus obtained, eight were judged non-defective in the visual examination.

### COMPARATIVE EXAMPLE 1

Glass substrates were produced in the same manner as in Example 1, except that the glass disks were not polished in the finish polishing step (step 6). As a result of the visual examination, none of the glass substrates was judged non-defective.

### COMPARATIVE EXAMPLE 2

In the processing steps beginning with the raw-plate cutting step (step 1) and ending with the cleaning step (step 7), the glass was held so that the side to be used as a data recording side was not the non-contact side. Specifically, in the disk cutout step (step 2) and the beveling step (step 3), a driving plate was pressed against a part other than the chuck part on the data recording side of each glass piece or disk. Furthermore, a resin case in which both sides of each glass substrate came into contact with the case was used for conveyance between steps. Except these, the same procedure as in Comparative Example 1 was conducted to produce glass substrates. These glass substrates were sampled to take ten glass substrates therefrom. As a result of the visual examination, none of these was judged non-defective with respect to the data recording side.

### COMPARATIVE EXAMPLE 3

Ten glass substrates were produced in the same manner as in Example 1, except that the glass was held so that the side to be used as a data recording side was not the non-contact side in the same manner as in Comparative Example 2. As a result of the visual examination, none of these was judged non-defective with respect to the data recording side.

### COMPARATIVE EXAMPLE 4

Ten glass substrates were produced in the same manner as in Example 2, except that the glass was held so that the side to be used as a data recording side was not the non-contact side in the same manner as in Comparative Example 2. As a result of the visual examination, two of these were judged non-defective with respect to the data recording side.

### COMPARATIVE EXAMPLE 5

Ten glass substrates were produced in the same manner as in Example 3, except that the glass was held so that the side to be used as a data recording side was not the non-contact side in the same manner as in Comparative Example 2. As a result of the visual examination, six of these were judged non-defective with respect to the data recording side.

### COMPARATIVE EXAMPLE 6

Ten glass substrates were produced in the same manner as in Example 4, except that the glass was held so that the side to be used as a data recording side was not the non-contact side in the same manner as in Comparative Example 2. As a result of the visual examination, all the ten glass substrates were judged non-defective with respect to the data recording side.

The results obtained in the Examples and Comparative Examples are shown in the following Table.

TABLE

| | Thickness | | Number of | Yield of |
|---|---|---|---|---|
| | removed by | Number of | non-defec- | mar-free |
| | polishing | Glass disks | tive glass | substrates |
| | (*1) (μm) | polished | substrates | (%) |
| Comparative | 0/0 | 9 | 0 | 0 |
| Example 1 | | | | |
| Example 1 | 20/10 | 9 | 8 | 88.9 |
| Example 2 | 40/20 | 9 | 8 | 88.9 |
| Example 3 | 60/30 | 9 | 9 | 100 |
| Example 4 | 80/40 | 9 | 8 | 88.9 |
| Comparative | 0/0 | 10 | 0 | 0 |
| Example 2 | | | | |
| Comparative | 20/10 | 10 | 0 | 0 |
| Example 3 | | | | |
| Comparative | 40/20 | 10 | 2 | 20 |
| Example 4 | | | | |
| Comparative | 60/30 | 10 | 6 | 60 |
| Example 5 | | | | |
| Comparative | 80/40 | 10 | 10 | 100 |
| Example 6 | | | | |

*1 (both sides)/(data recording side)

Comparisons between the Examples and the Comparative Examples show the following.

Comparison between Example 1 and Comparative Example 1 shows that even in the case where the top side is the non-contact side, it can be used as a data recording side only when it is polished in the finish polishing (step 6) to remove a surface layer in a thickness of 5 μm or larger therefrom.

Comparison between Examples 1 to 4 and Comparative Example 6 shows that keeping the data recording side being the non-contact side is effective in considerably reducing the thickness to be removed in the finish polishing step (step 6) as apparent from the fact that those Examples and the Comparative Example attained almost the same yield of mar-free substrates.

Since the invention has the constitution described above, it produces the following effects.

According to the process of the invention, the thickness of a surface layer to be removed from the data recording side by polishing can be reduced without lowering the yield of mar-free glass substrates. This is because one side of a float glass is polished in the finish polishing step (step 6) to remove a surface layer therefrom in a thickness of 5 μm or larger and the one side of the float glass is kept not substantially in contact with any jig in each of the processing steps other than the finish polishing step.

According to a preferred embodiment of the process of the invention in which in the finish polishing step (step 6), the one side of the float glass is polished to remove a surface layer therefrom in a thickness of from 5 to 40 μm, the thickness of a surface layer to be removed from the data recording side by polishing can be reduced and warpage-free glass substrates can be obtained without fail, while producing the effect described above.

According to another preferred embodiment of the process of the invention in which the non-contact side is the top side, the thickness of a surface layer to be removed from the data recording side by polishing can be minimized while producing the effects described above.

According to another aspect of the invention, mar-free glass substrates can be obtained at low processing cost in a high yield, because they are produced by the process of the invention and because the non-contact side is utilized as a data recording side.

According to still another aspect of the invention, an information recording device having high reliability in data recording can be obtained at low production cost without fail, because the glass substrate of the invention is integrated thereinto.

What is claimed is:

1. A process for producing a glass substrate for information recording media, which comprises polishing one side of a float glass in a finish polishing step to remove a surface layer therefrom in a thickness of 5 μm or larger and keeping the one side of the float glass not substantially in contact with any jig in each of the processing steps other than the finish polishing step.

2. The process for producing a glass substrate for information recording media of claim 1, wherein in the finish polishing step, the one side of the float glass is polished to remove a surface layer therefrom in a thickness of from 5 to 40 μm.

3. The process for producing a glass substrate for information recording media of claim 1 or 2, wherein the one side of the float glass which is kept not substantially in contact with any jig in each of the processing steps other than the finish polishing step is the top side.

4. A glass substrate for information recording media produced by the process of any one of claims 1 to 3,
wherein the one side of the float glass which was kept not substantially in contact with any jig in each of the processing steps other than the finish polishing step is utilized as a data recording side.

5. An information recording device having the glass substrate for information recording media of claim 4 integrated thereinto.
